(19) United States
(12) Patent Application Publication
(10) Pub. No.: US 2016/0034369 A1
(43) Pub. Date: Feb. 4, 2016

(54) DISK ARRAY APPARATUS AND CONTROL METHOD OF DISK ARRAY APPARATUS

(71) Applicant: NEC Corporation, Tokyo (JP)

(72) Inventor: Naoshi ORIHARA, Tokyo (JP)

(21) Appl. No.: 14/807,059

(22) Filed: Jul. 23, 2015

(30) Foreign Application Priority Data
Aug. 4, 2014 (JP) 2014-158662

(51) Int. Cl. G06F 11/20; G06F 3/06

(52) U.S. Cl. CPC G06F 11/2089; G06F 11/2094; G06F 3/0619; G06F 3/065; G06F 3/0689; G06F 2201/85

(57) ABSTRACT

A more space-saving capacity is realized by: preventing performance deterioration when a controller failure occurs; and reserving and releasing an usage area of the storage medium used on that occasion by internally measuring an operation load and a processing capability possessed by the apparatus and calculating a capacity required for maintaining a write cache periodically. In a disk array apparatus, the controller comprising: a host control unit to control reception of data from a host; a memory control unit to control a first memory and a second memory, the second memory for duplicating data with the first memory at a time of a controller failure, to set a free space of the second memory by making a free space of the first memory be increased and decreased in a predetermined time interval; and an HDD control unit to control sending and receiving of data to and from the disk array.

This application is based upon and claims the benefit of priority from Japanese Patent Application No. 2014-158662, filed on Aug. 4, 2014, the disclosure of which is incorporated herein in its entirety by reference.

### TECHNICAL FIELD

The present invention relates to a disk array apparatus. More particularly, the present invention relates to a disk array apparatus whose write response performance is improved by mounting a cache memory in a controller and duplicating data between controllers.

### BACKGROUND ART

In recent years, a disk array apparatus which has a plurality of controllers and duplicates data between controllers to improve write response performance has been developed. For example, FIG. 5 is a diagram showing a structure of a related disk array apparatus 500. In FIG. 5, the disk array apparatus 500 is connected to a host 50. The disk array apparatus 500 includes a first controller 501, a second controller 502 and a disk array 503 having a plurality of HDDs (Hard Disk Drives). The first controller 501 has a first cache memory 514, and the second controller 502 has a second cache memory 524.

Here, when a failure occurs in one of the controllers, in order to evade risk of data lost that would be caused by a failure of the other controller, the disk array apparatus 500 performs control for writing data into the HDDs without maintaining a write cache, that is, without allowing the write cache to function, and returning a reply.

FIG. 6 is a flow chart showing operations of the disk array apparatus 500. Using FIGS. 5 and 6, operations of the disk array apparatus 500 will be described. In FIG. 5, when a write Input/Output (hereinafter, referred to as I/O) is required from the host 50 (S601), the disk array apparatus 500 duplicates, if there is no failure occurring (No in S602), write data by the level 1 cache (hereinafter, the first and second cache memories 514 and 524 are collectively called in this way) (S605). A write I/O is a command for writing data from a cache memory to a disk array. In the stage when the duplication has completed, the disk array apparatus 500 replies to the host that the write I/O has completed (S606). The disk array apparatus 500 writes the data which has been already duplicated into the HDD (S607), and releases the level 1 cache which has been being used (S608). When a failure has occurred (Yes in S602), the disk array apparatus 500 writes write data into the HDD (S603) without allowing the cache memory to function, and in the stage when the HDD write has ended, replies to the host that the write I/O has completed (S604).

As a technology related to the above, patent document 1 (Japanese Patent Application Laid-Open No. 2009-053946) discloses a technology which can avoid performance deterioration and a complicated error handling associated with read via interconnect. In patent document 1, duplicated controllers are connected mutually by interconnect and signal lines between the controllers, and a signal line control module including a simple transmission register and a receiving register is mounted inside each controller. With this structure, the cache mirroring feature is realized only for write via interconnect.

Patent document 2 (Japanese Patent Application Laid-Open No. 2011-232962) discloses a technology which maintains data redundancy between controllers. In patent document 2, a disk array apparatus is provided with: a cache memory which stores write data from a host apparatus; and a flash memory drive having a storage capacity of two times or more as large as the mounted capacity of the cache memory. The controller of the disk array apparatus has a duplicated structure, and cache memory data on one controller is written in a flash memory drive as mirrored data, and the data is managed as cache memory mirrored data on the two controllers. By this, the above-mentioned technology is realized.

Patent document 3 (international publication number WO 2012/090239) discloses a technology which performs, in a storage system, data swapping dynamically between a storage unit storing control information and a cache partition. In patent document 3, the above-mentioned technology is realized by dividing a cache memory of a storage system into a plurality of partitions, and composing information of no smaller than one partition by data that includes control information and that is different from user data.

However, patent document 1 has a problem that, when a failure occurs in one of the controllers, the performance of the other controller for which cache mirroring has been composed also degrades. In other words, as a result of performing write into HDDs from a host without maintaining a write cache, the speed declines greatly.

Patent document 2 has a problem that a large storage capacity of a flash memory is required. The reason of this is that a cache memory for storing write data from a host apparatus and a flash memory drive having two times or more as large storage capacity as the mounted capacity of the cache memory are installed.

In patent document 3, there is a problem that, when a controller failure occurs, the failure cannot be handled because the controller is not of a duplicated structure.

In view of these points, an object of the present invention is to, in a disk array apparatus in which data is duplicated between controllers, prevent a performance deterioration using a small storage capacity on occasions when a controller failure occurs.

### SUMMARY

In the present invention, in order to settle the above-mentioned problem, a first view of the present invention is

a disk array apparatus including: a disk array having a plurality of HDDs; and a plurality of controllers, the disk array apparatus duplicating data between an optional pair of the controllers,

the controller comprising:

a host control unit configured to control reception of data from a host;

a memory control unit configured to control a first memory and a second memory, the second memory being a memory for duplicating data with the first memory at a time of a controller failure, to set a free space of the second memory by making a free space of the first memory be increased and decreased in a predetermined time interval; and

an HDD control unit configured to control sending and receiving of data to and from the disk array.

A second view of the present invention is

a control method using a disk array apparatus including a disk array including a plurality of HDDs and a plurality of controllers, the disk array apparatus duplicating data between an optional pair of the controllers. The method includes:

controlling reception of data from a host;

controlling a first memory and a second memory, the second memory being a memory for duplicating data with the first memory at a time of a controller failure;

controlling sending and receiving of data to and from the disk array; and

setting a free space of the second memory by making a free space of the first memory be increased and decreased in a predetermined time interval.

According to the present invention, performance deterioration on occasions when a controller failure occurs in a disk array apparatus which duplicates data between controllers can be prevented by using a small storage capacity.

### BRIEF DESCRIPTION OF THE DRAWINGS

Exemplary features and advantages of the present invention will become apparent from the following detailed description when taken with the accompanying drawings in which:

FIG. 1 is a block diagram showing an example of a structure of a disk array apparatus in a first exemplary embodiment of the present invention;

FIG. 2 is a flow chart showing an example of operations of a disk array apparatus in the first exemplary embodiment of the present invention;

FIG. 3A is a diagram showing a conceptual view showing a state of memory area reservation in the first flash memory;

FIG. 3B is a diagram showing a relation between a used amount of the level 1 cache and time in a cache memory;

FIG. 3C is a diagram showing a relation between a write cache hit rate and time in the first cache memory;

FIG. 3D is a diagram showing a temporal change in a total writing amount to the HDDs;

FIG. 3E is a diagram showing a temporal change of a busy rate of the HDDs;

FIG. 4 is a block diagram showing an example of a structure of a disk array apparatus in a second exemplary embodiment of the present invention;

FIG. 5 is a block diagram showing an example of a structure of a related disk array apparatus; and

FIG. 6 is a flow chart showing an example of operations of a related disk array apparatus.

### EXEMPLARY EMBODIMENT

### Exemplary Embodiments

Next, a detailed explanation will be given to exemplary embodiments with reference to drawings. In the following description on the drawings, identical or similar symbols are attached to parts that are identical or similar to each other. In this regard, however, a drawing represents a structure in an exemplary embodiment of the present invention schematically. Moreover, the exemplary embodiments of the present invention described below are just examples, and they can be changed appropriately in a range within which their natures are identical.

### First Exemplary Embodiment

Hereinafter, exemplary embodiments of the present invention will be described in detail with reference to a drawing.

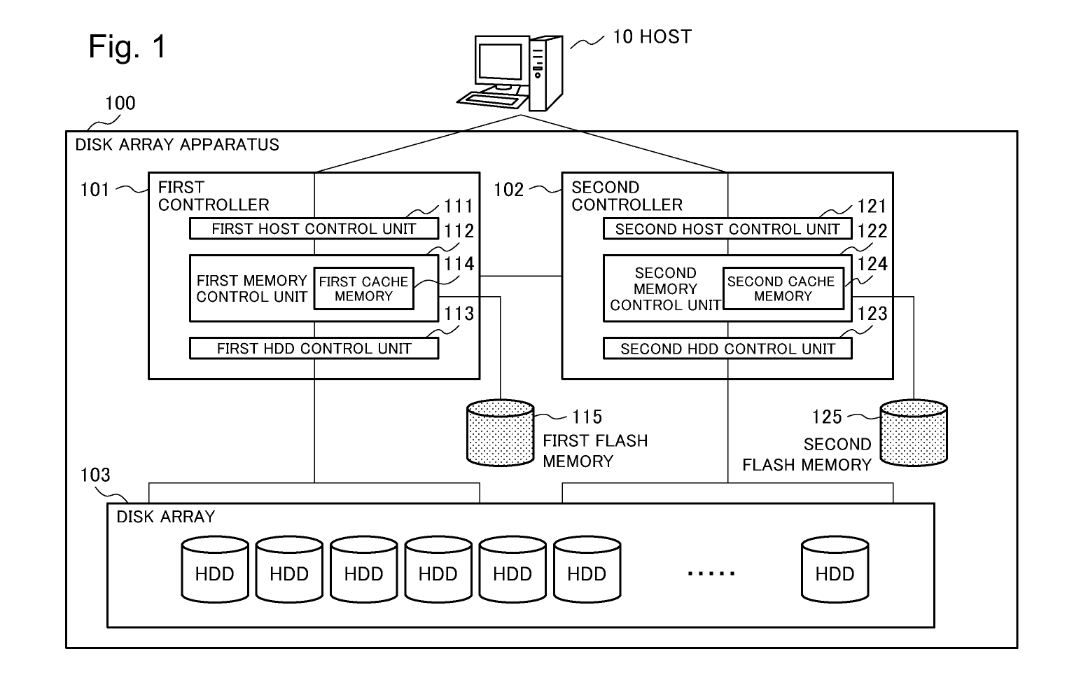

A configuration of a disk array apparatus 100 in the first exemplary embodiment will be described using FIG. 1.

FIG. 1 is a block diagram showing a structure of the disk array apparatus 100 in the first exemplary embodiment.

In FIG. 1, data is exchanged between a host 10 and the disk array apparatus 100. The disk array apparatus 100 has a controller. It is supposed that the controller includes CPU (Central Processing Unit). The controller is duplicated and includes a first controller 101 and a second controller 102. The first controller 101 and the second controller 102 may be collectively called a controller below. The first controller 101 and the second controller 102 are connected to a disk array 103 having a plurality of HDDs.

The first controller 101 has a first host control unit 111, a first memory control unit 112 and a first HDD control unit 113. The first memory control unit 112 includes a first cache memory 114 which is a first memory. The first memory control unit 112 is connected to a first flash memory 115 (a second memory) that is a high-speed non-volatile memory.

The first host control unit 111 measures a load from the host 10 such as a used amount and a write hit rate of the first cache memory 114 and a second cache memory 124 (these are collectively called a “level 1 cache” below). The first host control unit 111 makes an I/O completion notification to the host 10 be delayed.

A write hit rate (a write cache hit rate) means a proportion of successful writing processes into a cache to processes which have occurred in a predetermined period of time during which data has been being received. Accordingly, a situation where data keeps being received within an acceptable limit amount for the level 1 cache is expressed as “100% write cache hit”. Conversely, it is expressed as “a write cache hit rate is decreased (less than 100%)” to become a state where writing to the HDDs does not make it in time and a new writing operation is made to wait by having been reached the limit of the cache memory.

The first memory control unit 112 controls reserve and release of an area inside the level 1 cache (non-volatile memory) for conducting data duplication. Also, the first memory control unit 112 writes management information for data and the real data in the first flash memory 115. When processing for writing write data which has been accumulated in the first cache memory 114 into the HDDs of the disk array 103 is carried out in a manner being asynchronous with a host I/O, the first HDD control unit 113 measures a load state of the HDDs. The first HDD control unit 113 changes a speed of writing from the level 1 cache to the HDDs.

The first memory control unit 112 controls the first cache memory 114 and the first flash memory 115.

Similarly, the second controller 102 has a second host control unit 121, a second memory control unit 122 and a second HDD control unit 123.

The second host control unit 121 measures a level-1-cache used amount and a write hit rate which are loads from the host 10, and makes an I/O completion notification to the host 10 be delayed. The second memory control unit 122 controls reserve and release of an area in the level 1 cache (non-volatile memory) for data duplication. The second host control unit 121 writes management information of data and the real data into a second flash memory 125 that is a high-speed non-volatile memory. When processing for writing write data which has been accumulated in the second cache memory 124 into HDDs of the disk array 103 is carried out in a manner being asynchronous with a host I/O, the second HDD control unit 123 measures a load state of the HDDs. Moreover, the second HDD control unit 123 changes a speed to write in the HDDs.

The second memory control unit 122 controls the second cache memory 124 and the second flash memory 125.

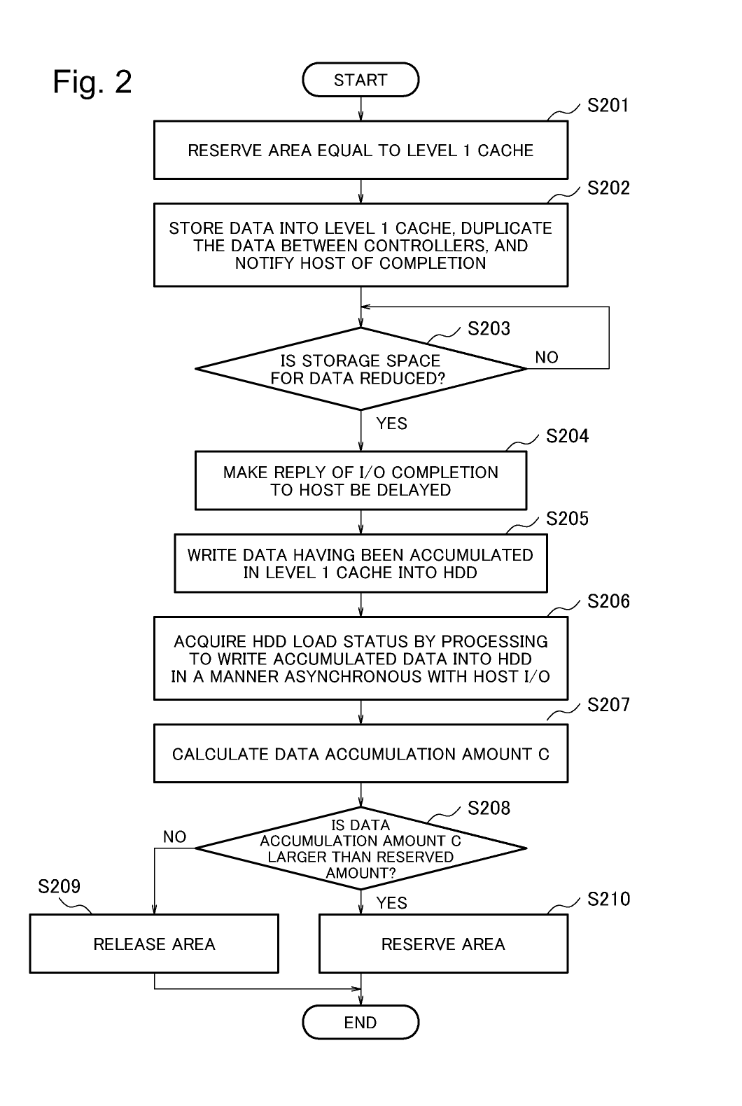

Operations of data writing in the disk array apparatus 100 in the first exemplary embodiment will be described using FIGS. 1 and 2.

FIG. 2 is a flow chart showing the operations of data writing by the controller of the disk array apparatus 100 in the first exemplary embodiment. Here, it is supposed that the first controller 101 accepts a write I/O, and description will be made focusing on operations of the first controller 101.

The first controller 101 of the disk array apparatus 100 reserves an area equal to the level 1 cache in the first flash memory 115 as an initial state (S201).

When operation is started and a write I/O issued by the host 10 is received, the first memory control unit 112 of the first controller 101 stores data into the first cache memory 114, and, further, makes the data be duplicated between the first and second controllers 101 and 102. As a result, the data is stored in the first and second cache memories 114 and 124. When the duplication is completed, the first controller 101 notifies the host of the completion (S202). When pieces of data have accumulated in the level 1 cache (the first cache memory 114), and a space available for storage does not exist anymore (Yes in S203), the first controller 101 makes time until a new write I/O is received by instructing the first host control unit 111 to make a reply to the host be delayed (S204). At the same time, the first controller 101 writes the data having been accumulated in the level 1 cache into the HDDs (S205). Basically, the first controller 101 instructs the first HDD control unit 113 to write the data to the HDDs by changing (speeding up) a speed of writing so as not to accumulate data to a level that data cannot be stored in the level 1 cache (the first cache memory 114) any more. Similarly, the second controller 102 also carries out data writing to the HDDs.

An amount of data to be written in from the level 1 cache is affected greatly by such as the performance of a single HDD (due to such as the number of rotations, an HDD type and I/O patterns), the number of HDDs mounted on the apparatus and a configuration of RAID (Redundant Arrays of Inexpensive Disks). Therefore, the first controller 101 acquires an HDD load status using, in the configuration under which the operation is being made, a data accumulation amount (a level 1 cache accumulation amount) in the level 1 cache that is being operated and a write speed of the first HDD control unit 113 (S206). That is, the first controller 101 checks whether there is a margin (room) in both of the level 1 cache accumulation amount and the HDDs. When judging that there is a room, the first controller 101 directs the first HDD control unit 113 to drop the writing speed of data to the HDDs from the usual writing speed temporarily within a range where the deferral state by the first host control unit 111 does not change. As a result, data which is to be accumulated in the level 1 cache increases, and, thus, the first memory control unit 112 of the first controller 101 measures a data accumulation amount in the increased state. Next, on the contrary, the first controller 101 directs the first HDD control unit 113 to maximize a writing speed of data so as to make the apparatus exhibit its abilities fully, and the first memory control unit 112 calculates data accumulation amount C of the level 1 cache on this occasion (S207).

The purpose of this calculation is to figure out how large empty area should be prepared in the flash memory 115 which is the data duplication destination of the level 1 cache (the first cache memory 114) based on an amount of vacancy in the level 1 cache that varies by changing a speed of writing from the level 1 cache to the HDDs. At the time of a controller failure, the level 1 cache and the flash memory 115 make data be duplicated. In other words, the first memory control unit 112 can calculate a free space of the flash memory 115 from the free space of the level 1 cache because they have the same data volume concerning the duplicated data. A method, not to drop a writing speed, but to gain time until a new write I/O is received by making a reply to the host be delayed as mentioned above may be also taken.

The first memory control unit 112 of the first controller 101 calculates data accumulation amount C periodically. The first memory control unit 112 determines whether data accumulation amount C is smaller than a free space that has been reserved in the first flash memory 115 or not via the first HDD control unit 113. When, as a result of the determination, data accumulation amount C is smaller than the free space, the first memory control unit 112 judges that the free space is excessive, and performs area release (that is, an empty area is reduced) (S209). On the contrary, when data accumulation amount C is larger than the free space as a result of the determination, the first memory control unit 112 judges that an empty area is short, and performs area reservation (in other words, an empty area is increased) (S210).

For example, when a failure occurs in the second controller 102, the first HDD control unit 113 of the first controller 101 increases a writing speed from the first cache memory 114 to the disk array 103 to the maximum immediately. Then, the first HDD control unit 113 makes the first memory control unit 112 operate. The first memory control unit 112 writes data stored in the first cache memory 114 into the empty area of the first flash memory 115 that has been set, and duplicates the data. After that, in the stage that writing into the first flash memory 115 has finished, the first host control unit 111 returns a reply to the host 10. By doing so, a controller failure can be handled even if the first flash memory 115 has a small capacity.

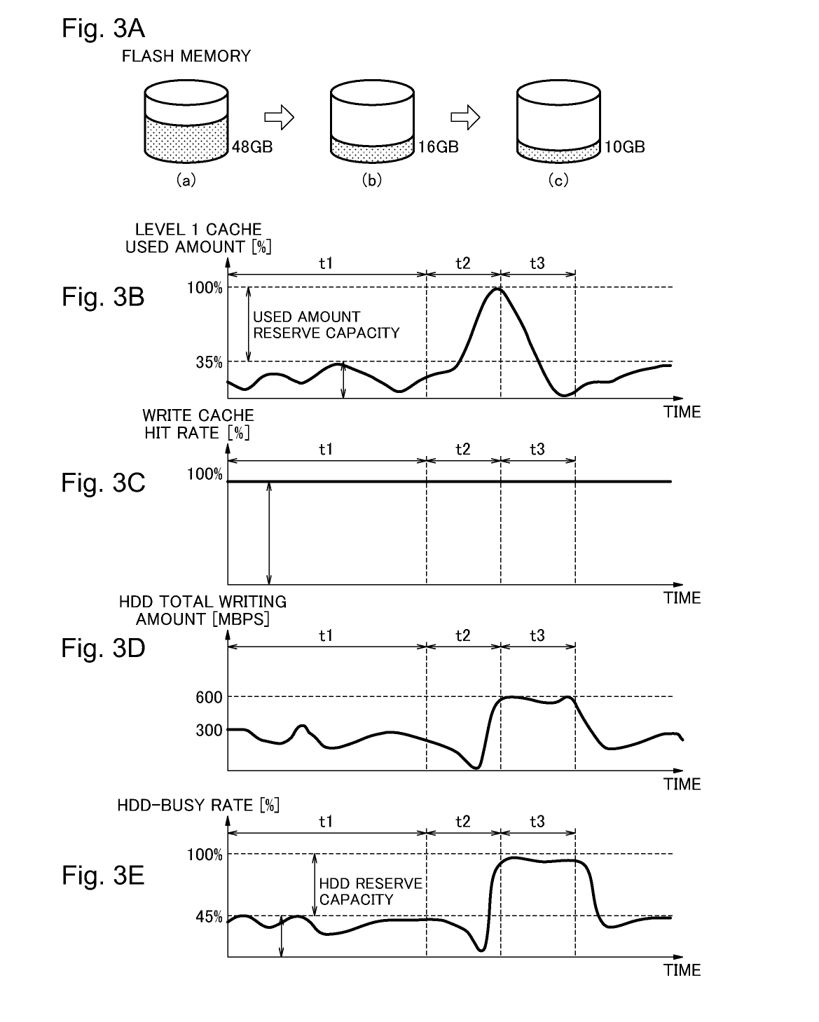

Detailed operations of the disk array apparatus 100 in the first exemplary embodiment will be described using FIGS. 1 and 3. In the following description, a case where a failure occurs in the second controller 102 will be described.

FIGS. 3A-3E are diagrams showing an image of operations of the first controller 101 of the disk array apparatus 100 in the first exemplary embodiment. FIG. 3A is a conceptual view showing a state of memory area reservation in the first flash memory 115. In FIG. 3A, a reserved storage area is reduced from status (a) to status (c) in sequence. FIG. 3B is a diagram showing, in a cache memory, a relation between a used amount of the level 1 cache and time. Meanwhile, in FIGS. 3B-3E, t1 indicates a period when a system is normally operating on the basis of an index example. A period during which a writing speed to the HDDs decreases is indicated by t2. A period during which a writing speed to the HDDs becomes biggest is indicated by t3. In t3, the first memory control unit 112 measures an ability to output data to the HDDs, which is being used as a accumulated level 1-cache used amount, and judges whether the level 1 cache used amount can be decreased further according to a measurement result. FIG. 3C is a diagram showing a relation between a write cache hit rate and time in the first cache memory 114. FIG. 3D is a diagram showing a temporal change in a total writing amount to the HDDs. FIG. 3E is a diagram showing a temporal change of a busy rate of the HDDs.

Here, at the time when constructing a system including the disk array apparatus 100, it is designed on the basis of a concrete construction index.

The following is an example of an index.
To mount HDDs so as to make a write cache hit rate in operation be 98% or more.
To make a loaded state (busy rate) of the HDDs be an average of 50% or less.
To make a CPU busy rate of a controller be an average of 50% or less.

Under such a system environment, a reserve capacity will be left in the disk array apparatus 100 potentially.

The flash memories 115 and 125 are provided in the disk array apparatus 100, a capacity suitable for the performance of an apparatus according to this exemplary embodiment is calculated, and capacity reservation is conducted in the cache memories 114 and 124. When a controller failure occurs, it is handled by duplicating data between the cache memory and the nonvolatile memory.

The first memory control unit 112 reserves an area having a capacity equal to that of the level 1 cache in the first flash memory 115 as a duplication destination of the level 1 cache (the first cache memory 114) installed in the first controller 101. The empty area reserved in the flash memory 115 by the above is maintained during a period in which the disk array apparatus 100 is normal and the controllers are being made to be redundant. In this regard, however, on this occasion, operation is conducted in the state that it does not perform duplication processing between the level 1 cache and the flash memory 115 (the flash memory 115 indicated in FIG. 3A (a)).

When operation starts actually under a system environment being operating on the basis of an index example (t1 in FIG. 3B), it is calculated that, around which degree of amount, a utilization amount of the level 1 cache varies by monitoring a write hit rate by the first host control unit 111 (FIG. 3C). On this occasion, while making a write cache hit rate not fall, the first memory control unit 112 accumulates not-yet-written data in the level 1 cache (an accumulation speed is also monitored).

FIG. 3B shows a situation that, while being in the state that write data is accumulated to a level of about 35% in the level 1 cache, write data is being written in the HDDs periodically (FIG. 3D and FIG. 3E).

The first memory control unit 112 monitors this situation periodically, and reduces the area in the first flash memory 115 to a size corresponding to the peak used amount observed during the monitoring period (to about 16 GB that is 35% of 48 GB) ((b) shown in FIG. 3A.)

Further, on occasions when a steady used amount of the level 1 cache is about 35% and a busy rate of the HDD is low (about 45% in the example of FIG. 3E), there is a possibility to be able to reduce an amount of write data to be accumulated in the level 1 cache if the HDDs are utilized to the full. Therefore, the first HDD control unit 113 slows down a writing speed (decrease a writing speed) to the HDDs to make transition to a state (t2 shown in FIG. 3B) in which accumulation in the level 1 cache more than the steady state is made within a range not reducing a write cache hit rate, and, then, a writing speed to the HDDs is made to transit to the maximum (t3 shown in FIG. 3B). By this, the first memory control unit 112 compares a write data amount accumulated in the level 1 cache per unit time and a write data amount to the HDDs, and, when there is a reserve capacity to write in the HDDs and when it is possible to reduce an area in the flash memory 115, reduces an area to about 10 GB further ((c) in FIG. 3A).

When operating normally, the first memory control unit 112 makes such an area in the flash memory 115 be increased and decreased periodically. For example, an empty area is increased and decreased in this way once a predetermined time. In normal times, the first memory control unit 112 uses an area having become free by reduction for a different use. For example, the first memory control unit 112 can store data and related files of application software which is frequently used in a cache and use it for a speedup or the like of the application.

When a controller failure occurs, the first memory control unit 112 can mitigate performance deterioration at the time of a controller failure by writing management information of data and the real data into an area reserved in the flash memory 115, and making a writing speed of the HDD transit to the maximum in parallel with the writing. Meanwhile, increase and decrease of a free space may be made in a regular time interval, or a time interval may be changed according to the need.

As it has been described above, according to the first exemplary embodiment of the present invention, in a disk array apparatus in which data is duplicated between controllers, performance deterioration when a controller failure occurs can be prevented using a small storage capacity. The reason of this is that performance deterioration when a controller failure occurs is prevented by using a high-speed storage medium, and an usage area of the storage medium to be used on that occasion is reserved and released by internally measuring an operation load and a processing capability possessed by the apparatus and calculating a capacity required for maintaining a write cache periodically.

### Second Exemplary Embodiment

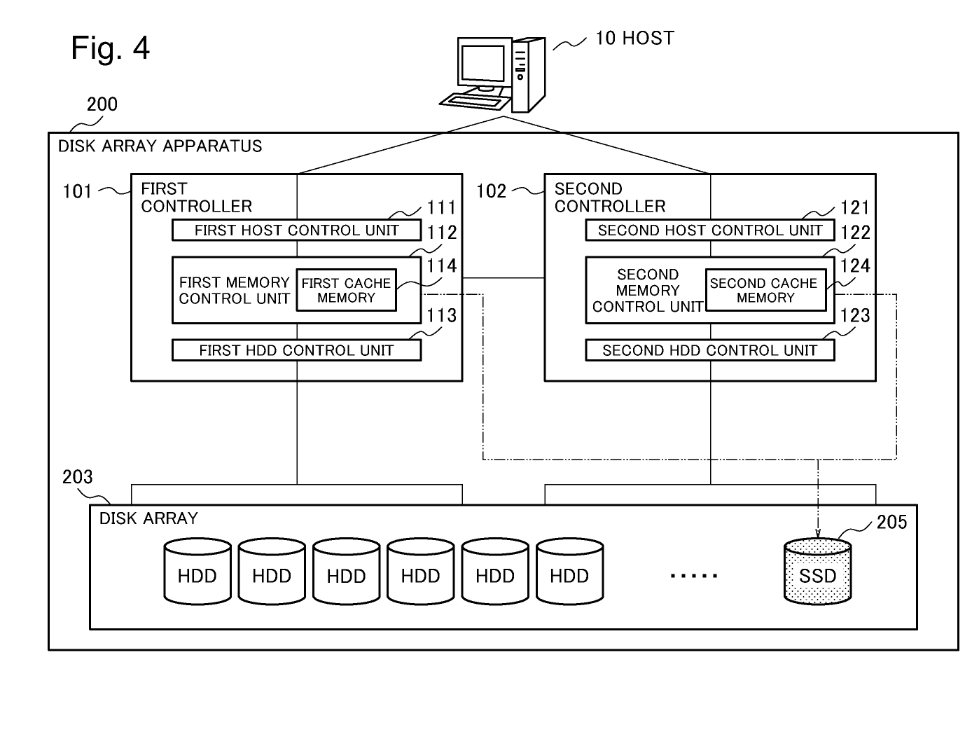

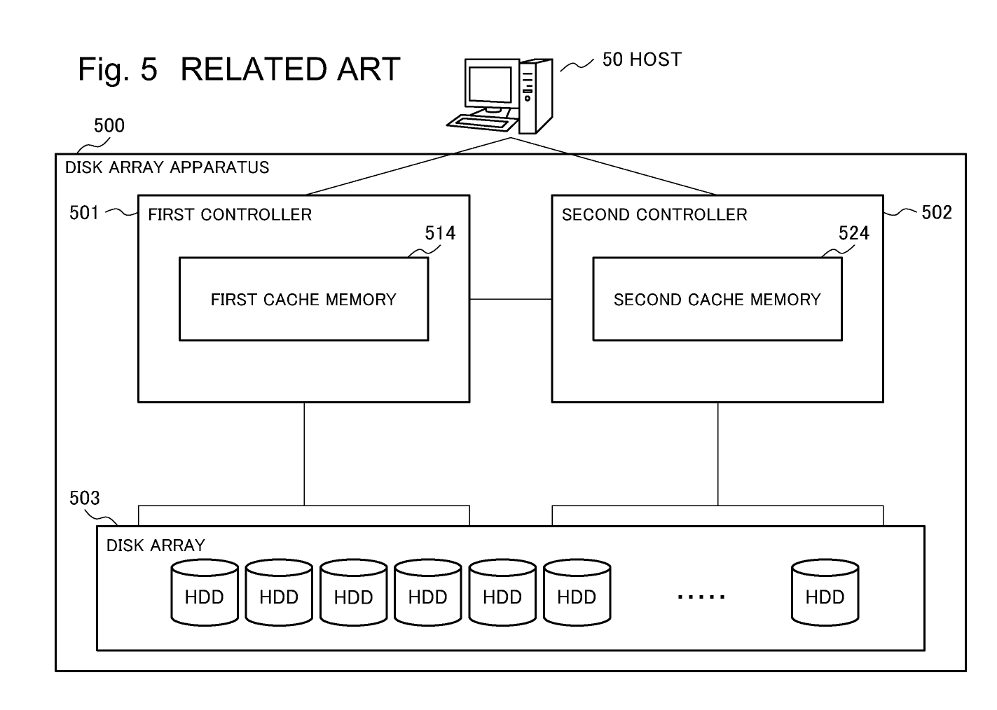

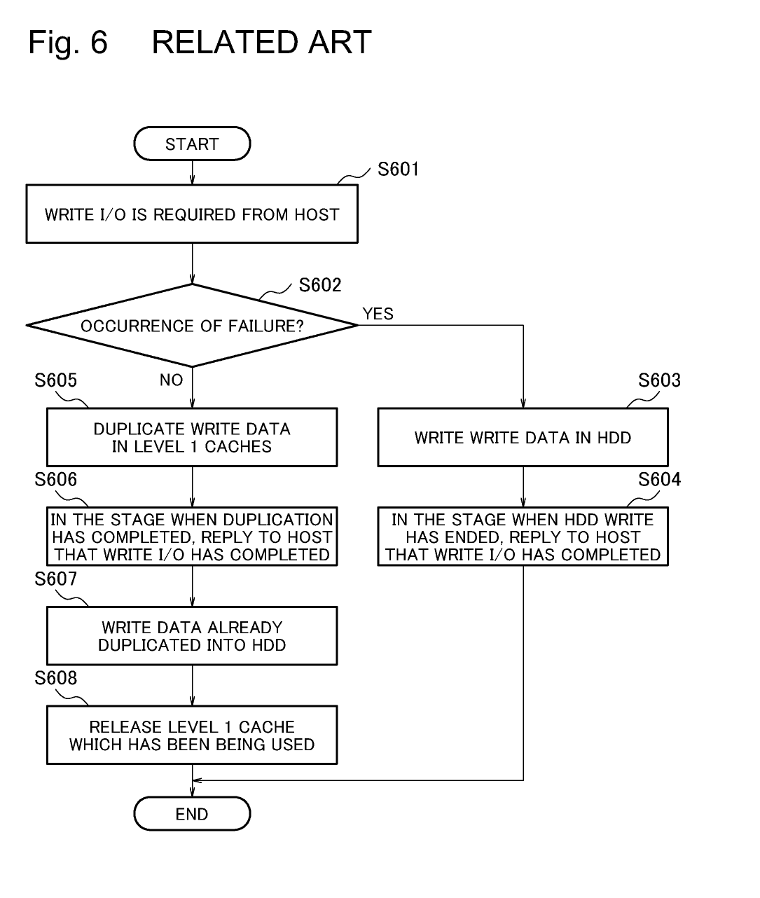

A configuration of a disk array apparatus 200 in the second exemplary embodiment will be described using FIG. 4.

FIG. 4 is a block diagram showing a structure of the disk array apparatus 200 in the second exemplary embodiment. In FIG. 4, the same numbers are attached to components of structures that are the same as those of the first exemplary embodiment, and description about those will be omitted. This exemplary embodiment is different from the first exemplary embodiment in a point that it includes in a disk array 203 a SSD 205 (Solid State Drive) which is a high-speed nonvolatile memory in addition to a plurality of HDDs.

In FIG. 4, data is exchanged between a host 10 and the disk array apparatus 200. The disk array apparatus 200 makes its controller be duplicated, and includes a first controller 101 and a second controller 102 connected with the disk array apparatus 200, respectively. The first controller 101 and the second controller 102 are connected to the disk array 203 having a plurality of HDDs.

The SSD 205 is controlled by a first memory control unit 112 in the first controller 101 or a second memory control unit 122 in the second controller 102.

The first memory control unit 112 and the second memory control unit 122 control reserve and release of an area in the SSD 205 for data duplication. Also, the first memory control unit 112 and the second memory control unit 122 write management information of data and the real data in the SSD 205.

Supposing a RAID is constructed in the disk array 203, the SSD 205 can compose a RAID and duplication of controllers. By this, it is possible to use the SSD 205 efficiently.

As it has been described above, according to the first exemplary embodiment of the present invention, in a disk array apparatus in which data is duplicated between controllers, performance deterioration when a controller failure occurs can be prevented using a small storage capacity. The reason of this is that performance deterioration on the time a controller failure occurs is prevented by using a high-speed storage medium, and that an usage area of the storage medium to be used on that occasion is reserved and released. The reservation and release are performed by internally measuring an operation load and a processing capability possessed by the apparatus and by calculating a capacity required for maintaining a write cache periodically.

In addition, by duplicating data using a non-volatile storage medium, information can be restored from the non-volatile storage medium even if double failures of controllers occur.

Meanwhile, the present invention is not limited to the above-mentioned exemplary embodiments, and it can be implemented with various changes and transformations within the range that does not deviate from the gist of the present invention.

### INDUSTRIAL APPLICABILITY

The present invention can be used in a disk array apparatus, and, more particularly, in a disk array apparatus which includes a cache memory installed in a controller and duplicates data between controllers to improve write response performance.

The previous description of the embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

### REFERENCE SIGNS LIST

10 Host

100 Disk array apparatus

101 First controller

102 Second controller

103 Disk array

111 First host control unit

112 First memory control unit

113 First HDD control unit

114 First cache memory

115 First flash memory

121 Second host control unit

122 Second memory control unit

123 Second HDD control unit

124 Second cache memory

125 Second flash memory

200 Disk array apparatus

203 Disk array

205 SSD

50 Host

500 Disk array apparatus

501 First controller

502 Second controller

503 Disk array

514 First cache memory

524 Second cache memory

1. A disk array apparatus including a disk array having a plurality of HDDs and a plurality of controllers, the disk array apparatus duplicating data between an optional pair of the controllers, the controller comprising:
a host control unit configured to control reception of data from a host;
a memory control unit configured to control a first memory and a second memory, the second memory being a memory for duplicating data with the first memory at a time of a controller failure, to set a free space of the second memory by making a free space of the first memory be increased and decreased in a predetermined time interval; and
a HDD control unit configured to control sending and receiving of data to and from the disk array.

2. The disk array apparatus according to claim 1, wherein
the memory control unit increases a data writing speed to the disk array at a time of the controller failure.

3. The disk array apparatus according to claim 1, wherein
the memory control unit makes transition to a state to allow accumulation to the first memory to be more than that of a steady state within a range not to reduce a write cache hit rate be made, and, after that, increases a writing speed to the disk array.

4. The disk array apparatus according to claim 1, wherein
the host control unit measures information from the host, and makes a notification to the host be delayed.

5. The disk array apparatus according to claim 1, wherein
the first memory is a cache memory, and the second memory is a non-volatile memory.

6. The disk array apparatus according to claim 1, wherein
an SSD (Solid State Drive) installed in the disk array is used in place of the second memory.

7. The disk array apparatus according to claim 1, wherein
the memory control unit conducts control of the first memory by writing data into the second memory by reserving and releasing a storage area.

8. The disk array apparatus according to claim 1, wherein
the HDD control unit measures a state of a load on the disk array, and changes a speed of writing to the disk array.

9. A control method using a disk array apparatus including: a disk array including a plurality of HDDs; and a plurality of controllers, the disk array apparatus duplicating data between an optional pair of the controllers, the method comprising:
controlling reception of data from a host;
controlling a first memory and a second memory, the second memory being a memory for duplicating data with the first memory at a time of a controller failure;
controlling sending and receiving of data to and from the disk array; and
setting a free space of the second memory by making a free space of the first memory be increased and decreased in a predetermined time interval.

10. The method according to claim 9, wherein
in the setting, increasing a data writing speed to the disk array at a time of the controller failure.

11. The method according to claim 9, wherein
in the setting, making transition to a state to allow accumulation to the first memory to be more than that of a steady state within a range not to reduce a write cache hit rate be made, and, after that, increasing a writing speed to the disk array.

12. The method according to claim 9, wherein
in controlling reception of data, measuring information from the host, and making a notification to the host be delayed.

13. The method according to claim 9, wherein
the first memory is a cache memory, and the second memory is a non-volatile memory.

14. The method according to claim 9, wherein
an SSD (Solid State Drive) installed in the disk array is used in place of the second memory.

15. The method according to claim 9, wherein
in the setting, conducting control of the first memory by writing data into the second memory by reserving and releasing a storage area.

16. The method according to claim 9, wherein
in the controlling sending and receiving of data, measuring a state of a load on the disk array, and changing a speed of writing to the disk array.
